(19) United States
(12) Patent Application Publication
(10) Pub. No.: US 2006/0114481 A1
(43) Pub. Date: Jun. 1, 2006

(54) Object-oriented ink selection

(75) Inventor: Lee C. Moore, Rochester, NY (US)

Correspondence Address: OLIFF & BERRIDGE, PLC., P.O. BOX 19928, ALEXANDRIA, VA, 22320, US

(73) Assignee: XEROX CORPORATION, Stamford, CT (US)

(21) Appl. No.: 10/998,650

(22) Filed: Nov. 30, 2004

(51) Int. Cl. G06K 15/02

(52) U.S. Cl. 358/1.9; 358/1.11

(57) ABSTRACT

A reprographic device includes an object oriented rendering system in which the objects that make up a composite document are rendered (processed) uniquely dependent on the object type, such that textual detail will be processing one way using a first type of black colorant with visual characteristics optimized for readability and photographic objects or bitmaps will be processed another way with a second, different type of black colorant optimized for reproducing photographic content. The device uses two different single component black formulations, the first having a matte finish for text and the second component having a gloss finish compatible with color image reproduction. The first and second types may both be different single component black colorants. Alternatively, the first black may be a matte black and the second colorant may be an overcoat, such as a varnish or clear toner, applied over the matte black to form a gloss finish.

### BACKGROUND

Disclosed systems and methods render object-oriented image data in a multi-color digital color printing or reproduction system. More specifically, a black colorant selection is made among matte and gloss finish single component black colorant formulations based on determined object type.

The use of color in the digital environment has created problems for color printers trying to produce satisfactory results. One problem facing color electrophotographic printers stems from the proliferation of desktop publishing software programs or applications. Such desktop publishing systems allow the user to combine different types of objects into a composite document. For example, a user can combine photographic images, text, and business graphics (charts) into a single document wherein these images may be either color or black/white.

If each type of data is rendered using the same rendering criteria, satisfactory results cannot be achieved without compromise when using a typical three or even four-color printing system (e.g., cyan, yellow, magenta, and optionally black). For example, lets assume that a color system is trying to render a composite document with a photographic image and a business graphic. In order to achieve high quality rendering of a photographic image, the color system may have to skew the color attributes in a certain way, but this skewing may cause the business graphics in the same composite document to appear washed out. Similarly, if the color printing system is skewed to ensure saturated vivid colors for the business graphics, the photographic image in the composite document may lose its life-like appearance. Prior systems have attempted to resolve some of these issues, including U.S. Pat. No. 5,704,021 to Smith et al. However, such solutions do not address problems with printing of black in desktop publishing applications.

Monochrome electrophotographic printers were primarily developed for text printing and produce output with a very readable matte black ink. Because only monochrome printing is achievable in such printers, concerns were only with development of a suitable black formulation for text. Such monochrome printers are not capable of printing color content. Current electrophotographic color printers can produce colored content and typically produce glossy output that is suitable for image reproduction of graphics or photographic reproduction. Such color printers are also capable of rendering black, using either a dedicated single component black formulation or process black, formed by a combination of non-black colorants (e.g., CYM in combination). However, such color printers can produce a distracting glare when printing text content because the black is produced glossy for compatibility with photographic content. Thus, printing of documents having combinations of data object types (i.e., graphics, photographic images, text) with such printers without compromise has been difficult to achieve.

Various efforts to render colored documents are disclosed in U.S. Pat. No. 6,542,173 to Buckley, U.S. Pat. No. 5,966,462 to Linder et al., U.S. Pat. No. 5,923,821 to Birnbaum et al., U.S. Pat. No. 6,259,536 to Coleman, U.S. Pat. No. 5,784,172 to Coleman, U.S. Pat. No. 5,371,531 to Rezanka et al., U.S. Pat. No. 5,568,169 to Dudek et al., U.S. Pat. No. 6,302522 to Rumph et al., U.S. Pat. No. 6,753,976 to Torpey et al., and U.S. Pat. No. 6,246,419 to Loce et al. All of these are commonly assigned to Xerox and are hereby incorporated herein by reference in their entireties. Alternative rendering strategies are disclosed in WO/0077723 to Levmart. However, these solutions are primarily concerned with solving intercolor bleed problems, or pile height problems and not optimization of black reproduction.

### SUMMARY

To resolve this problem of reproducing black in a composite document having multiple different types of objects, an object oriented rendering system has been developed in which the objects that make up a composite document are rendered (processed) uniquely dependent on the object type, such that textual detail will be processing one way using a first type of black colorant with visual characteristics optimized for readability and photographic objects or bitmaps will be processed another way with a second, different type of black colorant optimized for reproducing photographic content. As a result, individual objects can be rendered to optimize their quality.

One aspect involves a method for classifying object oriented image data to be rendered by an object oriented rendering system that configures a reprographic device having two different single component black formulations, each with differing visual characteristics, to print a first object type using a first black formulation and a second object type using a second black formulation.

In various exemplary embodiments, the first object type is a textual object and the first black formulation has a lower gloss formulation than the second black formulation.

In various exemplary embodiments, the second object type is one of a graphic object and/or a photographic object and the second black formulation has a high gloss finish.

In various exemplary embodiments, the first black formulation is a single component dry toner formulation having a matte finish.

In various exemplary embodiments, the second black formulation is a single component dry toner formulation having a gloss finish.

In various other exemplary embodiments, the second black formulation is comprised of the first black formulation overcoated with a finish coat, such as a varnish or clear toner that provides a different visual appearance for the second black formulation.

Another aspect of the invention is a reprographic device having at least one non-black colorant and first and second black colorants, each black colorant having differing visual characteristics.

In various exemplary embodiments, the first black colorant is a black formulation having a low gloss or matte finish suitable for reproduction of textual content and the second black colorant has a higher gloss finish better adapted for reproduction of graphics and photographic object image data.

In various exemplary embodiments, the reprographic device has five colorant housings, one each to produce Cyan, Yellow, Magenta, low gloss Black and high gloss Black (CYMK₁K₂).

In various exemplary embodiments, the low gloss black formulation is a single component black formulation.

In various exemplary embodiments, the high gloss black formulation is a single component black formulation.

In other various exemplary embodiments, the high gloss black formulation consists of the low gloss black formulation overcoated with a finish coat of a varnish, clear toner or other high gloss coating, with the finish coat being contained in a housing separate from the low gloss black formulation and applied in a subsequent step.

Further objects and advantages will become apparent from the following descriptions of the various embodiments and characteristic features of object-oriented ink selection using multiple black colorant formulations.

### BRIEF DESCRIPTION OF THE DRAWINGS

The following is a brief description of each drawing used to describe aspects of an object-oriented ink selection method and system, and thus, such drawings are being presented for illustrative purpose only and should not limit the scope of the appended claims, wherein:

FIG. 1 illustrates an exemplary multi-color printing device having two different black components;

FIG. 2 illustrates an exemplary five-color xerographic printing device;

FIG. 3 illustrates an exemplary document to be printed that contains a combination of object types;

FIG. 4 illustrates a flow diagram showing an exemplary object-oriented black component selection according to a first embodiment;

FIG. 5 illustrates color component selection settings for the various objects in the document of FIG. 3 in accordance with the FIG. 4 selection method;

FIG. 6 illustrates a flow diagram showing an exemplary object-oriented black component selection according to a second embodiment; and

FIG. 7 illustrates color component selection settings for the various objects in the document of FIG. 3 in accordance with the FIG. 6 selection method.

### DETAILED DESCRIPTION OF PREFERRED EMBODIMENTS

The following will be a detailed description of the drawings illustrated. In this description, as well as in the drawings, like reference numerals represent like devices, circuits, or equivalent circuits which perform the equivalent functions.

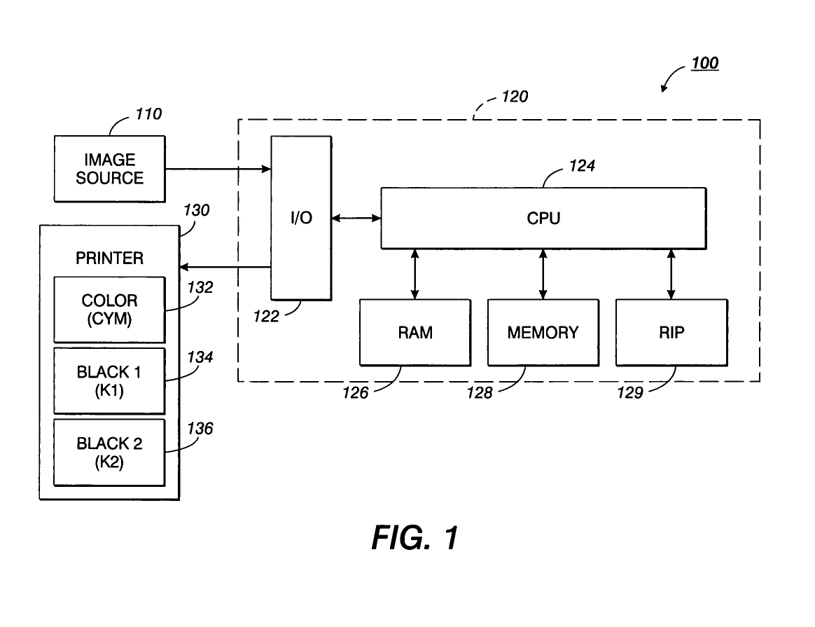

The invention is directed to object-oriented black colorant selection for printing by a reprographic device. Broadly, as illustrated in FIG. 1, a reprographic device 100 includes an image source 110 that can provide image data in a suitable format, such as any combination of ASCII data, bitmapped data, geometric data, graphics primitives, line drawings, vectors, page description language, etc. However, preferred image data is provided in a page description language (PDL) format, such as Postscript®, PDF, Structured Vector Graphics (SVG), etc. that provides descriptors to identify various object types, including text or graphics.

The image source 110 may include one or more of a scanner, computer, image input terminal, a network, digital camera, or any similar imaging or image generation device. The reprographic device 100 further includes a control system 120, implemented in hardware or software, that resides locally or remote to the reprographic device 100 and renders the image for suitable reproduction by a print engine 130. The print engine 130 generates a printed output image on a suitable print medium based on the rendered print data received from the control system 120. Print engine 130 differs from most conventional print engines by inclusion of at least one non-black color housing 132 and two separate housings 134, 136 used to provide two differing black component formulations. The black formulations 134, 136 differ in visual appearance when applied to a print medium. For example, one may have a matte finish while the other has a glossy finish.

Control system 120 can include, for example, an input/output (I/O) interface 122 that sends and/or receives data to/from image source 110 and print engine 130. A CPU 124 provides processing control of various component modules and computational processes, including RAM 126, memory 128, and Raster Input Processor (RIP) 129.

Typical raster input processors (RIP) 129, also called interpreters, such as the Adobe Postscript Raster Image Processor, available from Adobe Systems, Inc., process data from the PDL data for subsequent printing by the reprographic device 100. PDL interpreters can exist within the control system 120 as shown, but may alternatively be provided at the print engine 130, or at the image data source 110, or may even reside elsewhere in communication with the image source and print engine. The RIP 130 within the print engine decomposes the job for printing on a particular reprographic device 120. The rendering breaks down the objects of a print document into main object types, including text, graphics (e.g., line drawings, polygons, or vectors), and photographic images (e.g., bitmaps or raster data).

The Raster Image Processor (RIP) 129 is preferably implemented on a general purpose computer. However, the interpreter can also be implemented on a special purpose computer, a programmed microprocessor or microcontroller and peripheral integrated circuit elements, an ASIC or other integrated circuit, a digital signal processor, a hardwired electronic or logic circuit such as a discrete element circuit, a programmable logic device such as a PDL, PLA, FPGA or PAL, or the like.

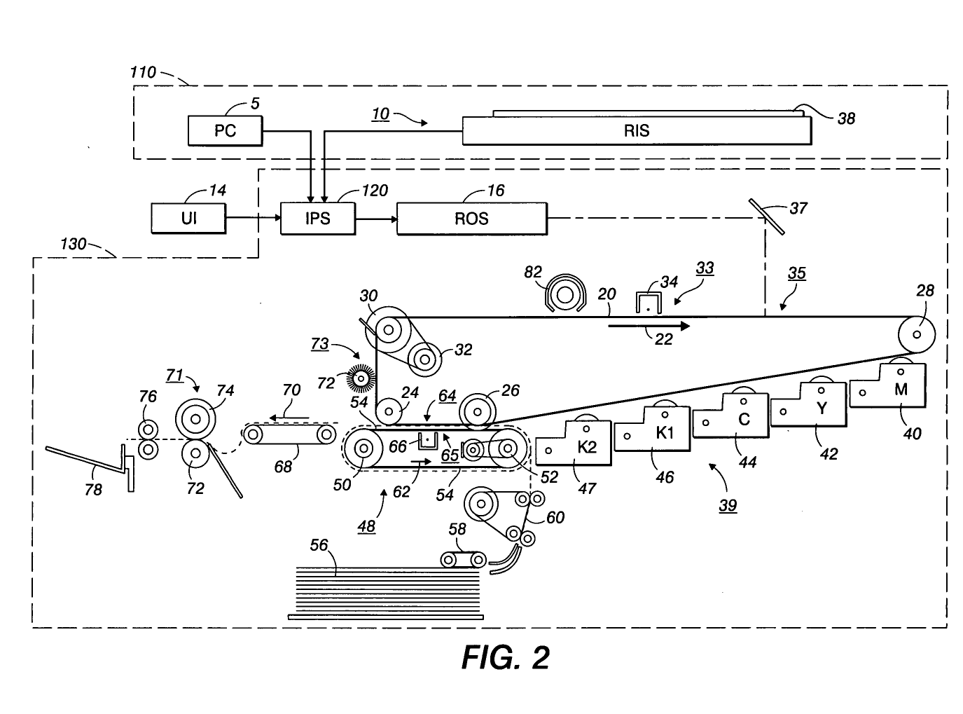

The actual reprographic process can be implemented using various device types, such as facsimile machines, copiers, printers, etc. Moreover, such devices can use various printing technologies, including, but not limited to, xerography using dry toner or liquid toner development, ink jet printing, solid ink printing, etc. An exemplary embodiment illustrated in FIG. 2 is directed to a laser xerographic system that uses dry toner formulations for each color.

In a laser xerographic printing process, an electrostatic charge pattern or latent image corresponding to an original is formed on an insulating medium. A viewable record is then produced by developing the latent image with particles of granulated material to form a powder image thereof. Thereafter, the visible powder image is fused to the insulating medium, or transferred to a suitable support material and fused thereto. Development of the latent image is achieved by bringing a developer mix into contact therewith. Typical developer mixes generally comprise dyed or colored thermoplastic particles of granulated material known in the art as toner particles, which are mixed with carrier granules, such as ferromagnetic granules. When appropriate, toner particles are mixed with carrier granules and the toner particles are charged triboelectrically to the correct polarity. As the developer mix is brought into contact with the electrostatic latent image, the toner particles adhere thereto. However, as toner particles are depleted from the developer mix, additional toner particles must be supplied.

An ESS (electronic subsystem) or image processing station (both referred to as IPS), indicated generally by the reference numeral 120, contains data processing and controller electronics which prepare and manage the image data flow to a raster output scanner (ROS) indicated generally by the reference numeral 16. A network of one or more personal computers (PC), indicated generally by the reference numeral 5, is shown interfacing with or in communication with IPS 120. A user interface (UI), indicated generally by the reference numeral 14, is also in communication with IPS 120.

UI 14 enables an operator to control and monitor various operator adjustable functions and maintenance activities. The operator actuates the appropriate keys of UI 14 to adjust the parameters of the copy. UI 14 may be a touch screen, or any other suitable control panel, providing an operator interface with the system. The output signal from UI 14 is transmitted to IPS 120. UI 14 may also display electronic documents on a display screen (not shown in FIG. 2), as well as carry out the image rendering selections.

A multiple color original document 38 may be positioned on (optional) raster input scanner (RIS), indicated generally by the reference numeral 10. The RIS contains document illumination lamps, optics, a mechanical scanning drive, and a charge coupled device (CCD array) or full width color scanning array. RIS 10 captures the entire image from original document 38 and converts it to a series of raster scan lines and moreover measures a set of primary color densities, i.e., red, green and blue densities, at each point of the original document. RIS 10 may provide data on the scanned image to IPS 120, indirectly to PC 5 and/or directly to PC 5.

Documents in digital or other forms may be created, screened, modified, stored and/or otherwise processed by PC 5 prior to transmission/relay to EPS 120 for printing on printer 130. The display of PC 5 may show electronic documents on a screen (not shown in FIG. 2). EPS 120 may include the processor(s) and controller(s) (not shown in FIG. 2) required to perform the adaptive image rendering system of the present invention.

IPS 120 also may transmit signals corresponding to the desired electronic or scanned image to ROS 16, which creates the output copy image. Thus, any of elements 5, 14, 10 may form the image source 110 of FIG. 1 and IPS 120 may form at least part of control system 120 of FIG. 1.

With continued reference to FIG. 2, printing engine 130 is an electrophotographic printing machine. ROS 16 includes a laser with rotating polygon mirror blocks. The ROS 16 illuminates, via mirror 37, the charged portion of a photoconductive belt 20 of print engine 130 at a predetermined rate of M×N pixels per inch, to achieve a set of subtractive primary latent images. M×N may represent 400×400 dpi (dots per inch), 600×600 dpi, or even asymmetrical resolutions, such as 300×1200 dpi.

The ROS 16 will expose the photoconductive belt to record the latent images which correspond to the signals transmitted from IPS 12. One latent image is developed with cyan developer material from a cyan colorant housing 44. Another latent image is developed with magenta developer material from a magenta colorant housing 40, and the third latent image is developed with yellow developer material from a yellow colorant housing 42. A black latent image may be developed in lieu of or in addition to other (colored) latent images using one or more black colorants from a first black colorant housing 46 and a second black colorant housing 47. These developed images are transferred to a copy sheet in superimposed registration with one another to form a multicolored image on the copy sheet. This multicolored image is then fused to the copy sheet forming a color copy.

Photoconductive belt 20 of marking engine 130 is preferably made from a photoconductive material. The photoconductive belt moves in the direction of arrow 22 to advance successive portions of the photoconductive surface sequentially through the various processing stations disposed about the path of movement thereof. Photoconductive belt 20 is entrained about rollers 24 and 26, tensioning roller 28, and drive roller 30. Drive roller 30 is rotated by a motor 32 coupled thereto by suitable means such as a belt drive. As roller 30 rotates, it advances belt 20 in the direction of arrow 22.

Initially, a portion of photoconductive belt 20 passes through a charging station, indicated generally by the reference numeral 33. At charging station 33, a corona generating device 34 charges photoconductive belt 20 to a relatively high, substantially uniform potential.

Next, the charged photoconductive surface is rotated to an exposure station, indicated generally by the reference numeral 35. Exposure station 35 receives a modulated light beam corresponding to information derived by RIS 10 having multicolored original document 38 positioned thereat or from PC 5 having a Page Description Language document. The modulated light beam impinges on the surface of photoconductive belt 20. The beam illuminates the charged portion of the photoconductive belt to form an electrostatic latent image. The photoconductive belt is exposed three or four times to record three or four latent images thereon.

After the electrostatic latent images have been recorded on photoconductive belt 20, the belt advances such latent images to a development station, indicated generally by the reference numeral 39. The development station includes five individual developer units indicated by reference numerals 40, 42, 44, 46 and 47. The developer units are of a type generally referred to in the art as “magnetic brush development units.”

Typically, a magnetic brush development system employs a magnetizable developer material including magnetic carrier granules having toner particles adhering triboelectrically thereto. The developer material is continually brought through a directional flux field to form a brush of developer material. The developer material is constantly moving so as to continually provide the brush with fresh developer material. Development is achieved by bringing the brush of developer material into contact with the photoconductive surface. Developer units 40, 42, and 44, respectively, apply toner particles of a specific non-black color which corresponds to the complement of the specific color separated electrostatic latent image recorded on the photoconductive surface.

The color of each of the toner particles is adapted to absorb light within a preselected spectral region of the electromagnetic wave spectrum. For example, an electrostatic latent image formed by discharging the portions of charge on the photoconductive belt corresponding to the green regions of the original document will record the red and blue portions as areas of relatively high charge density on photoconductive belt 20, while the green areas will be reduced to a voltage level ineffective for development. The charged areas are then made visible by having developer unit 40 apply green absorbing (magenta) toner particles onto the electrostatic latent image recorded on photoconductive belt 20.

Similarly, a blue separation is developed by developer unit 42 with blue absorbing (yellow) toner particles, while the red separation is developed by developer unit 44 with red absorbing (cyan) toner particles. Developer unit 46 contains black toner particles having a first black colorant visual property and may be used to develop the electrostatic latent image formed from a black and white original document or from textual regions of a document. In an exemplary embodiment, the first black colorant is formulated to have a matte appearance that enhances the readability of text. Developer unit 47 may contain a second black colorant having a different formulation and corresponding different visual appearance from the first black colorant, such as a high gloss finish rather than a matte finish. Alternatively, developer housing 47 can contain a varnish or other overcoat layer that can be applied over the first black colorant to change its visual appearance (e.g., from matte to gloss finish). Each of the developer units is moved into and out of an operative position. In the operative position, the magnetic brush is substantially adjacent the photoconductive belt, while in the nonoperative position, the magnetic brush is spaced therefrom. During development of each electrostatic latent image, only one developer unit is in the operative position, the remaining developer units are in the nonoperative position.

After development, the toner image is moved to a transfer station, indicated generally by the reference numeral 65. Transfer station 65 includes a transfer zone, generally indicated by reference numeral 64. In transfer zone 64, the toner image is transferred to a sheet of support material, such as plain paper amongst others. At transfer station 65, a sheet transport apparatus, indicated generally by the reference numeral 48, moves the sheet into contact with photoconductive belt 20. Sheet transport 48 has a pair of spaced belts 54 entrained about a pair of substantially cylindrical rollers 50 and 53. A sheet gripper (not shown in FIG. 1) extends between belts 54 and moves in unison therewith.

A sheet (not shown in FIG. 2) is advanced from a stack of sheets 56 disposed on a tray. A friction retard feeder 58 advances the uppermost sheet from stack 56 onto a pre-transfer transport 60. Transport 60 advances the sheet to sheet transport 48. The sheet is advanced by transport 60 in synchronism with the movement of the sheet gripper. The sheet gripper then closes securing the sheet thereto for movement therewith in a recirculating path. The leading edge of the sheet (again, not shown in FIG. 2) is secured releasably by the sheet gripper.

As belts 54 move in the direction of arrow 62, the sheet moves into contact with the photoconductive belt, in synchronism with the toner image developed thereon. In transfer zone 64, a corona generating device 66 sprays ions onto the backside of the sheet so as to charge the sheet to the proper magnitude and polarity for attracting the toner image from photoconductive belt 20 thereto. The sheet remains secured to the sheet gripper so as to move in a recirculating path for three cycles. In this way, three or four different color toner images are transferred to the sheet in superimposed registration with one another.

One skilled in the art will appreciate that the sheet may move in a recirculating path for multiple cycles when under color removal (UCR) is used. Each of the electrostatic latent images recorded on the photoconductive surface is developed with the appropriately colored toner and transferred, in superimposed registration with one another, to the sheet to form the multicolored copy of the colored original document. After the last transfer operation, the sheet transport system directs the sheet to a vacuum conveyor 68. Vacuum conveyor 68 transports the sheet, in the direction of arrow 70, to a fusing station, indicated generally by the reference numeral 71, where the transferred toner image is permanently fused to the sheet. Thereafter, the sheet is advanced by a pair of rolls 76 to a catch tray 78 for subsequent removal therefrom by the machine operator.

The final processing station in the direction of movement of belt 20, as indicated by arrow 22, is a photoreceptor cleaning apparatus, indicated generally by the reference numeral 73. A rotatably mounted fibrous brush 72 may be positioned in the cleaning station and maintained in contact with photoconductive belt 20 to remove residual toner particles remaining after the transfer operation. Thereafter, lamp 82 illuminates photoconductive belt 20 to remove any residual charge remaining thereon prior to the start of the next successive cycle.

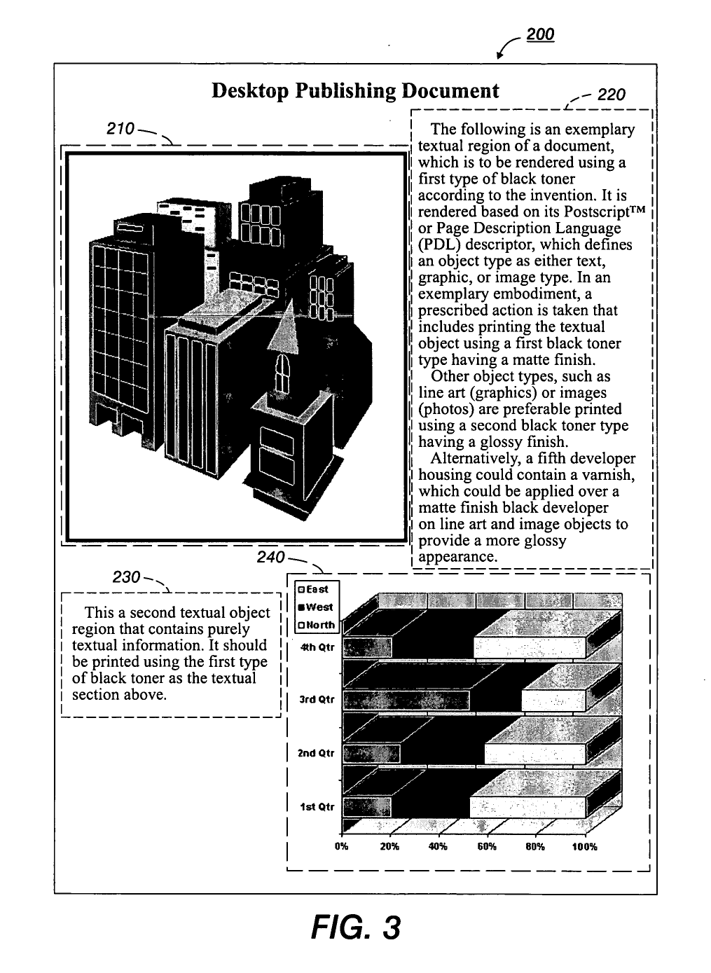

A user may create a job representing a page or document to be printed having one or more sections of text, graphics and photos as shown in FIG. 3. Alternatively, a job may be scanned in or copied from an existing file using image source 110. This job is preferably encoded into a page description language, such as Postscript® a trademark of Adobe Systems Inc., by the image source 110 and sent to a printer driver for printing by print engine 130. Postscript® is a programming language optimized for printing graphics or text. It provides a convenient language in which to describe images in a device independent manner. That is, the same code is used regardless of the printer or output device.

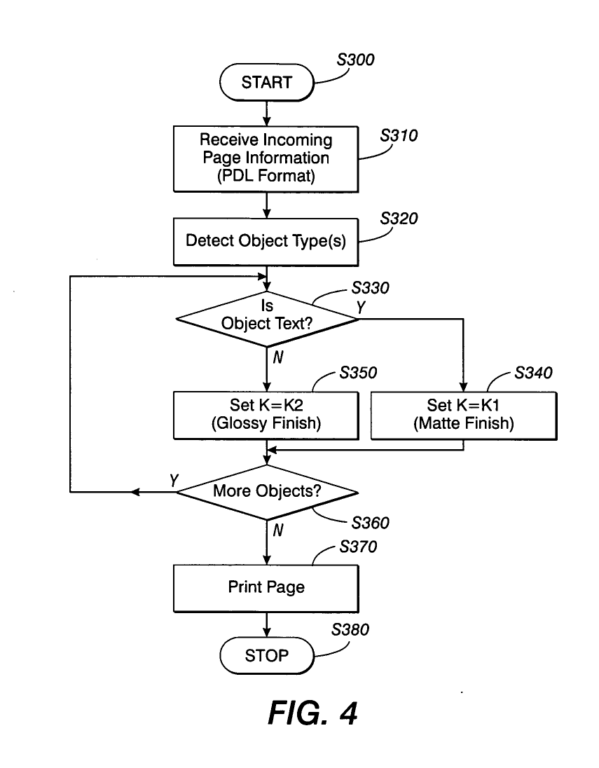

In the example shown, region 210 of desktop publishing document 200 is a photographic object type, regions 220 and 230 are text-based object types, and region 240 is a graphical object type in the form of a graphic chart. An exemplary method of rendering document 200 using the system of either FIG. 1 or FIG. 2 is illustrated with reference to FIG. 4.

The rendering process starts at step S300 and advances to step S310 where incoming page/document information is received in a suitable image format. In an exemplary embodiment, the document information is received from image source 110 and received in or converted to a PDL format, which includes identifiers that allow determination of object type. Flow then advances to step S320 where the object type(s) of the document are detected. This can be performed by RIP 129 of control system 120. From step S320, flow advances to step S330 where it is determined whether a first object is a text object. If so, flow advances to step S340 where the black colorant K is set equal to K₁. K₁ is formulated so as to produce a more readable textual content than formulation K₂, which is formulated so as to produce a better graphic or photographic content, such as when black is found within a photograph or graphical image. If not, flow advances to step S350 where the black colorant K is set equal to K₂.

From steps S340 or S350, flow advances to step S360 where it is determined whether there are additional objects within the document 200. If so, flow returns to step S330. If not, flow advances to step S370 where the page/document in rasterized form is printed using print engine 130. The process stops at step S380 upon completion of step S370.

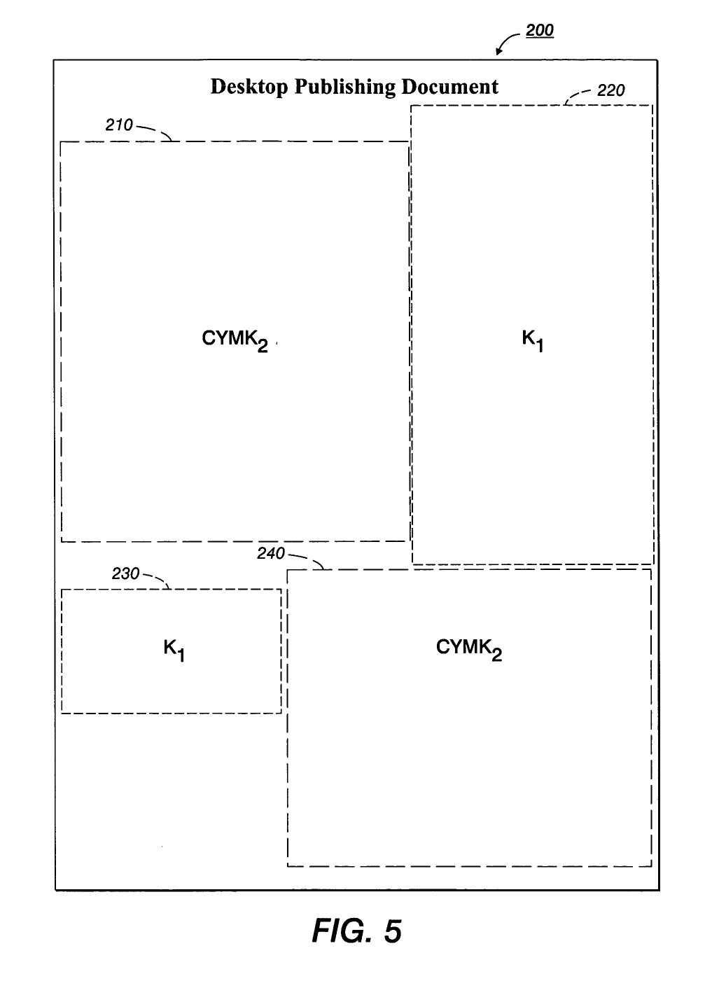

Thus, upon completion of the rendering, the various objects are rendered so that, the particular print engine 130 used prints each object using the colorants shown in FIG. 5. That is, textual content within regions 220, 230 is printed using the first black colorant K₁, and black content within non-text regions 210 and 220 is printed using the second black colorant K₂, with various non-black colorants including one or more of CYM being selected to print non-black color content.

In this exemplary embodiment, K₁ is preferably a single component black formulation. That is, a colorant formulation that primarily uses a black colorant, rather than a “process” black made using a combination of two or more non-black colorants layered to form an image that approximates a black image (i.e., a combination of C, Y and M colorants). Moreover, K₁ is formulated to have an appearance that enhances the representation of textual content. One particularly relevant aspect of this enhancement is to provide a black formulation that after fusing has a matte appearance, which reduces or eliminates glare by reducing light reflection or refraction. A suitable black toner formulation is Xerox part number 6R1006 available from Xerox Corporation.

K₂, on the other hand, is formulated to have an appearance that enhances the representation of graphical or photographic content. One particularly relevant aspect of this enhancement is to provide K₂ with a high gloss appearance that more closely conforms to the high gloss used for the other non-black colorants. This results in an optimum graphical representation.

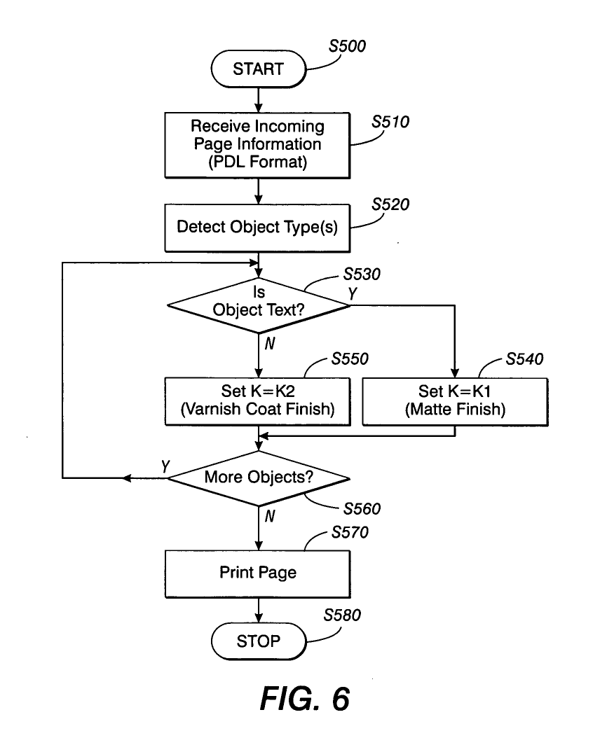

An alternative exemplary method of rendering document 200 in FIG. 3 using the system of either FIG. 1 or FIG. 2 is illustrated with reference to FIG. 6. The rendering process starts at step S500 and advances to step S510 where incoming page/document information is received in a suitable image format. In an exemplary embodiment, the document information is received from image source 110 and received in or converted to a PDL format, which includes identifiers that allow determination of object type. Flow then advances to step S520 where the object type(s) of the document are detected. This can be performed by RIP 129 of control system 120. From step S520, flow advances to step S530 where it is determined whether a first object is a text object. If so, flow advances to step S540 where the black colorant K is set equal to K₁. K₁ is formulated so as to produce a more readable textual content, such as by having a matte finish. If not, flow advances to step S550 where the black colorant K is set equal to K₁ and K₂. In this embodiment, K₂ is a finish coat that is applied over the base black K₁ to modify its appearance so as to be more suitable for reproduction of graphic or photographic content. In a preferred embodiment, the finish coat is a varnish overcoat, clear toner formulation, or other overcoat that will increase the gloss of the first black colorant. A suitable finish coat formulation would be housed in housing 136 (FIG. 1) or 47 (FIG. 2) and may include, for example a varnish composition, clear toner, or other finish coating capable of increasing the gloss appearance of the K₁ ink so as to more closely match the gloss of the other colorants. Various varnish formulations are known in the art that can apply a high gloss finish to a base colorant. A suitable clear toner can be achieved by providing a toner formulation without any pigment, and with optional additives that adjust a resultant gloss value to a suitable value. One suitable clear toner can be found in U.S. Pat. No. 6,066,422 to Blaszak et al., commonly assigned to Xerox Corporation and hereby incorporated herein by reference in its entirety. Clear toners may have advantages over other finish coats, such as better compatibility with other colorant toners, allowing interchangeability of colorant housing contents. Additionally, clear toners may be more compatible with fusing properties of the other colorants.

From steps S540 or S550, flow advances to step S560 where it is determined whether there are additional objects within the document 200. If so, flow returns to step S530. If not, flow advances to step S570 where the page/document is printed using print engine 130. In the illustrated embodiment, the objects are rendered by RIP 129 and converted to rasters prior to printing The process stops at step S580 upon completion of step S370.

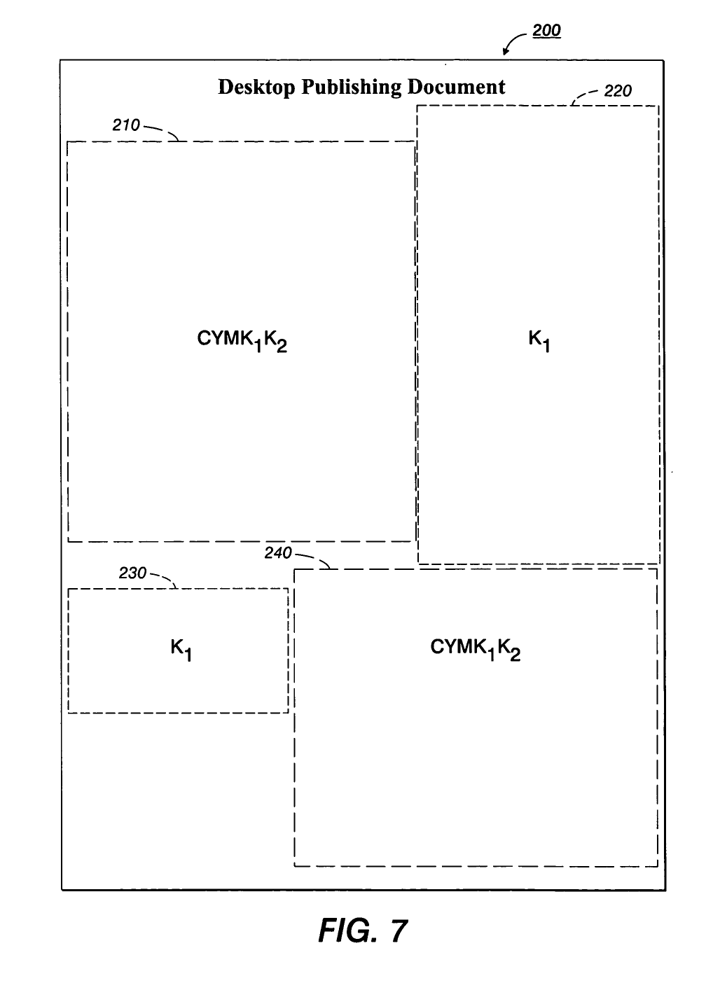

Thus, upon completion of the rendering, the various objects are rendered so that the particular print engine 130 used prints each object using the colorants shown in FIG. 7. That is, textual content within regions 220, 230 is printed using the first black colorant K₁, and black content non-text regions 210 and 220 are printed using the first black colorant K₁ followed by an overcoat of the first black colorant with the overcoat finish K₂.

In this exemplary embodiment, K, is preferably a single component black formulation. That is, a colorant formulation that primarily uses a black colorant, rather than a “process” black made using a combination of two or more non-black colorants layered to form an image that approximates a black image (i.e., a combination of C, Y and M colorants). Moreover, K₁ is formulated to have an appearance that enhances the representation of textual content. One particularly relevant aspect of this enhancement is to provide a black formulation that after fusing has a matte appearance, which reduces or eliminates glare by reducing light reflection or refraction. K₂, on the other hand, is formulated to modify the appearance of K₁ so that it has an appearance that enhances the representation of graphical or photographic content. One particularly relevant aspect of this enhancement is to provide K₂ with a high gloss appearance that more closely conforms to the high gloss used for the other non-black colorants. This results in an optimum graphical representation.

While this invention has been described in conjunction with the exemplary embodiments outlined above, various alternatives, modifications, variations, and/or improvements, whether known or that are, or may be, presently unforeseen, may become apparent. Accordingly, the exemplary embodiments of the invention as set forth above are intended to be illustrative, not limiting. Various changes may be made without departing from the spirit and scope of the invention. Therefore, the systems and methods according to this invention are intended to embrace all known, or later-developed, alternatives, modifications, variations, and/or improvements.

What is claimed is:

1. A method of object-oriented reproduction of a color composite image using a reprographic device, comprising:
receiving image data from an image source representing a document;
detecting object types within the image data, including at least identification of textual object types and non-textual object types;
setting detected textual object types to print black areas with a first type of black colorant optimal for readability of textual content;
setting detected non-textual object types to print black areas with a second type of black colorant optimal for reproducing graphic and/or photographic content;
reproducing the document using a reprographic device, including printing textual objects using the first type of black colorant, printing non-textual black objects with the second type of black colorant, and printing color areas using at least one non-black colorant.

2. The method according to claim 1, wherein the first black colorant has a formulation with a lower gloss than the second black colorant formulation.

3. The method according to claim 2, wherein the first black colorant has a matte finish and the second black colorant has a gloss finish.

4. The method according to claim 1, wherein the first black colorant is a single component black formulation.

5. The method according to claim 4, wherein the second black colorant is a single component black formulation differing from the first black colorant and having a visual characteristic compatible with the at least one non-black colorant.

6. The method according to claim 4, wherein the second black colorant is formed by use of the first black colorant overcoated with a finish coat that modifies a visual property of the first black colorant.

7. The method according to claim 6, wherein the finish coat is a varnish.

8. The method according to claim 6, wherein the finish coat is a clear toner.

9. The method according to claim 1, wherein the reprographic device is a color xerographic machine using dry development materials for the first and second black colorants.

10. A color reprographic device for reproduction of a color composite image using a reprographic device, comprising:
a control system that receives a document from an image source containing image data representing a composite image;
an interpreter that detects object types within the image data, including at least identification of textual object types and non-textual object types, the interpreter setting detected textual object types to print black areas with a first type of black colorant optimal for readability of textual content and setting detected non-textual object types to print black areas with a second type of black colorant optimal for reproducing graphic and/or photographic content; and
a color print engine provided with a first black colorant housing, a second black colorant housing, and at least one non-black colorant housing,
wherein the print engine prints textual objects using the first type of black colorant, prints non-textual black objects with the second type of black colorant, and prints color areas using at least one non-black colorant.

11. The color reprographic device according to claim 10, wherein the first black colorant has a formulation with a lower gloss than the second black colorant formulation.

12. The color reprographic device according to claim 10, wherein the first black colorant has a matte finish and the second black colorant has a gloss finish.

13. The color reprographic device according to claim 10, wherein the first black colorant is a single component black formulation.

14. The color reprographic device according to claim 10, wherein the second black colorant is a single component black formulation differing from the first black colorant.

15. The color reprographic device according to claim 10, wherein the second black colorant is formed by use of the first black colorant overcoated with a finish coat that modifies a visual property of the first black colorant.

16. The color reprographic device according to claim 15, wherein the finish coat is a varnish.

17. The color reprographic device according to claim 15, wherein the finish coat is a clear toner.

18. The color reprographic device according to claim 10, wherein the reprographic device is a color xerographic machine using dry development materials for the first and second black colorants.

19. The color reprographic device according to claim 18, wherein the device includes five developer housings, one for each of cyan, yellow and magenta colorants, a first single component matte finish black colorant, and a second single component capable of producing a gloss black finish.

20. The color reprographic device according to claim 19, wherein the second single component is an overcoat that when applied over the first single component matte finish black colorant forms a gloss black finish.

21. A color xerographic device using dry development materials for reproduction of a color composite image, comprising:
a control system that receives a document from an image source containing image data representing a composite image;
an interpreter that detects object types within the image data, including at least identification of textual object types and non-textual object types, the interpreter setting detected textual object types to print black areas with a first type of black colorant optimal for readability of textual content and setting detected non-textual object types to print black areas with a second type of black colorant optimal for reproducing graphic and/or photographic content; and
a color print engine provided with a first black colorant housing containing a single component black forming the first type of black colorant and having a matte finish when applied on a substrate, a second black colorant housing containing a single component capable of producing the second type of black colorant and having a gloss black finish, and at least one non-black colorant housing containing at least one non-black colorant,
wherein the print engine prints textual objects using the first type of black colorant, prints non-textual black objects with the second type of black colorant, and prints color areas using at least one non-black colorant.

22. The color xerographic device according to claim 21, wherein the second black colorant housing contains an overcoat that when applied over the first single component matte finish black colorant forms a gloss black finish.
